(19) United States
(12) Patent Application Publication
(10) Pub. No.: US 2026/0089483 A1
(43) Pub. Date: Mar. 26, 2026

(54) SYSTEM AND METHOD FOR WIRELESS ROAMING RESOURCE RESERVATION OR NEGOTIATION

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Ken Kinwah Ho, San Jose, CA (US); Hongyuan Zhang, Fremont, CA (US)

(21) Appl. No.: 19/338,485

(22) Filed: Sep. 24, 2025

Related U.S. Application Data
(60) Provisional application No. 63/698,533, filed on Sep. 24, 2024.
(60) Provisional application No. 63/775,621, filed on Mar. 21, 2025.
(60) Provisional application No. 63/801,690, filed on May 7, 2025.

(51) Int. Cl. H04W 8/14; H04W 72/04; H04W 88/10

(52) U.S. Cl. CPC H04W 8/14; H04W 72/04; H04W 88/10

(57) ABSTRACT

Embodiments of a method and apparatus for wireless communications are disclosed. In an embodiment, a wireless device includes a controller configured to generate a roaming message for wireless roaming from a current serving AP multi-link device (MLD) to a target AP MLD and a transceiver configured to transmit the roaming message during the wireless roaming for a resource reservation or negotiation of frame exchanges between the wireless device and the target AP MLD.

### CROSS-REFERENCE TO RELATED APPLICATIONS

This application is entitled to the benefit of U.S. Provisional Patent Application Ser. No. 63/698,533, filed on Sep. 24, 2024, U.S. Provisional Patent Application Ser. No. 63/775,621, filed on Mar. 21, 2025, and U.S. Provisional Patent Application Ser. No. 63/801,690, filed on May 7, 2025, the contents of each of which are incorporated by reference herein in their entireties.

### SUMMARY

Embodiments of a method and apparatus for wireless communications are disclosed. In an embodiment, a wireless device includes a controller configured to generate a roaming message for wireless roaming from a current serving AP multi-link device (MLD) to a target AP MLD and a transceiver configured to transmit the roaming message during the wireless roaming for a resource reservation or negotiation of frame exchanges between the wireless device and the target AP MLD. Other embodiments are also disclosed.

In an embodiment, the wireless device includes a non-AP MLD with at least one affiliated non-AP station (STA).

In an embodiment, the roaming message includes a roaming preparing request or response frame or a roaming executing request or response frame.

In an embodiment, the transceiver is further configured to transmit the roaming message through the serving AP MLD during the wireless roaming for the resource reservation or negotiation of the frame exchanges between the wireless device and the target AP MLD.

In an embodiment, the transceiver is further configured to transmit the roaming message to the target AP MLD during the wireless roaming for the resource reservation or negotiation of the frame exchanges between the wireless device and the target AP MLD.

In an embodiment, the resource reservation or negotiation of the frame exchanges between the wireless device and the target AP MLD includes the resource reservation or negotiation regarding one of or multiple of Mirrored Stream Classification Service (MSCS), Stream Classification Service (SCS), and block acknowledgement (BA).

In an embodiment, the roaming message includes a roaming preparing response frame that includes a Mirrored Stream Classification Service (MSCS) element, and the transceiver is further configured to transmit the roaming preparing response frame through the serving AP MLD during the wireless roaming for the resource reservation or negotiation regarding MSCS communications between the wireless device and the target AP MLD.

In an embodiment, the target AP MLD decides whether the MSCS element is accepted or rejected, and announces an agreed MSCS agreement to the wireless device when accepted.

In an embodiment, the roaming message includes a roaming preparing response frame that includes a Stream Classification Service (SCS) element, and the transceiver is further configured to transmit the roaming preparing response frame through the serving AP MLD during the wireless roaming for the resource reservation or negotiation regarding SCS communications between the wireless device and the target AP MLD.

In an embodiment, the target AP MLD decides whether the SCS element is accepted or rejected, and announces an agreed SCS agreement in the roaming preparing response frame.

In an embodiment, the current serving AP MLD and the target AP MLD belong to a seamless mobility domain (SMD), and all AP MLDs in the SMD have same block acknowledgement (BA) agreement capability.

In an embodiment, all AP MLDs in the SMD have same BA bitmap size.

In an embodiment, the roaming message includes a roaming preparing response frame that includes block acknowledgement (BA) parameters, which are used to describe a BA agreement, and the transceiver is further configured to transmit the roaming preparing response frame through the serving AP MLD during the wireless roaming for a negotiation of the BA agreement between the wireless device and the target AP MLD.

In an embodiment, the target AP MLD decides whether the BA agreement is accepted or rejected, and announces the BA agreement when accepted.

In an embodiment, the wireless device is compatible with an Institute of Electrical and Electronics Engineers (IEEE) 802.11 protocol.

In an embodiment, the wireless device includes a non-AP station (STA) MLD, and the transceiver includes a wireless transceiver configured to transmit the roaming message through a wireless link.

In an embodiment, the resource reservation or negotiation of the frame exchanges between the wireless device and the target AP MLD includes a resource reservation or negotiation regarding one of or multiple of Emergency Preparedness Communication Service (EPCS), Target Wake Time (TWT), and a Traffic Identifier (TID)-to-link mapping agreement.

In an embodiment, a non-AP station (STA) multi-link device (MLD) includes a controller configured to generate a roaming preparing response frame for wireless roaming from a current serving access point (AP) MLD to a target AP MLD and a transceiver configured to transmit the roaming preparing response frame during the wireless roaming to the current serving AP MLD that sends the roaming preparing response frame on behalf of the non-AP STA MLD to the target AP MLD for a resource reservation or negotiation regarding Mirrored Stream Classification Service (MSCS), Stream Classification Service (SCS), and block acknowledgement (BA) between the non-AP STA MLD and the target AP MLD.

In an embodiment, a method for wireless communications includes at a wireless device, generating a roaming message for wireless roaming from a current serving access point (AP) multi-link device (MLD) to a target AP MLD and from the wireless device, transmitting the roaming message during the wireless roaming for a resource reservation or negotiation of frame exchanges between the wireless device and the target AP MLD.

In an embodiment, the wireless device includes a non-AP MLD with at least one affiliated non-AP station (STA).

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a multi-link (ML) communications system that is used for wireless communications in accordance with example embodiments.

FIG. 3 depicts a wireless device in accordance with example embodiments.

FIG. 4 illustrates a seamless roaming operation of a non-AP (STA) MLD in accordance with example embodiments.

FIG. 5 illustrates a frame format in accordance with example embodiments.

FIG. 6 is a process flow diagram of a method for wireless communications in accordance with example embodiments.

Throughout the description, similar reference numbers may be used to identify similar elements.

### DETAILED DESCRIPTION

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. A wireless device can roam within a wireless communications system in a roaming operation, such as, a seamless roaming operation. To facilitate the proper data transmission within a wireless communications system, there is a need for wireless roaming technology that can efficiently and securely convey wireless roaming information, for example, information related to data, communications links, and/or wireless devices (e.g., operation and/or capability parameters of wireless devices) within the wireless communications system.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

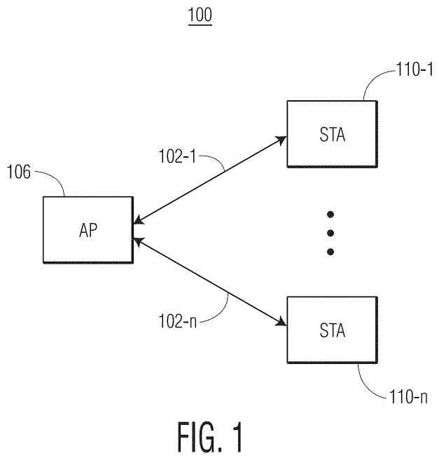

FIG. 1 depicts a wireless (e.g., WiFi) communications system 100 in accordance with example embodiments. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy”communication protocols.

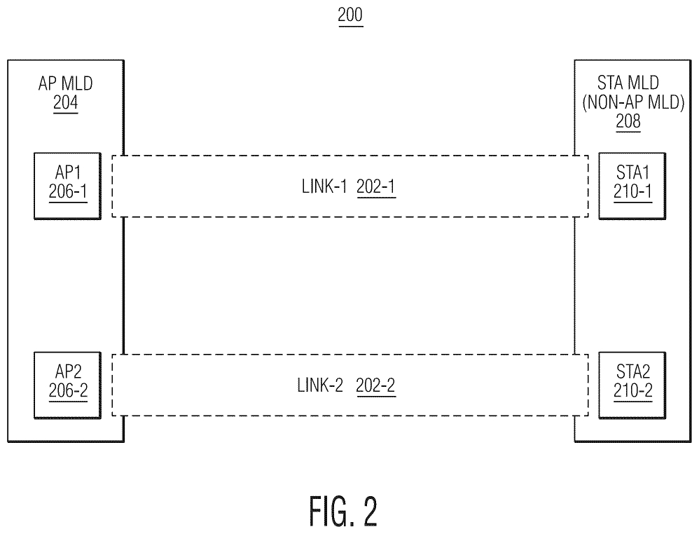

FIG. 2 depicts a multi-link (ML) communications system 200 that is used for wireless (e.g., WiFi) communications in accordance with example embodiments. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities common to all APs affiliated with the AP MLD 204 (e.g., association establishment, reordering of frames, etc.) and a link specific part of the AP MLD 204, i.e., the APs 206-1 and 206-2, implement upper layer MAC specific to a link and lower layer MAC functionalities (e.g., beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc. in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

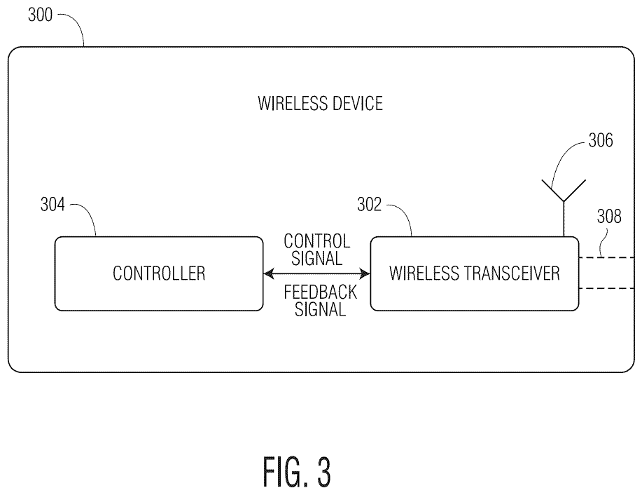

FIG. 3 depicts a wireless device 300 in accordance with example embodiments. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with example embodiments, the controller 304 is configured to generate a roaming message for wireless roaming from a current serving AP multi-link device (MLD) to a target AP MLD, and the wireless transceiver 302 is configured to transmit the roaming message during the wireless roaming for a resource reservation or negotiation of frame exchanges between the wireless device and the target AP MLD, for example, wirelessly transmit the roaming message through the at least one antenna 306. In some embodiments, the wireless device 300 includes a non-AP MLD with at least one affiliated non-AP station (STA). In some embodiments, the roaming message includes a roaming preparing request or response frame or a roaming executing request or response frame. In some embodiments, the wireless transceiver is further configured to transmit the roaming message to the current serving AP MLD that sends the roaming message on behalf of the wireless device to the target AP MLD during the wireless roaming for the resource reservation or negotiation of the frame exchanges between the wireless device and the target AP MLD. In some embodiments, the wireless transceiver is further configured to transmit the roaming message through the serving AP MLD during the wireless roaming for the resource reservation or negotiation of the frame exchanges between the wireless device and the target AP MLD. In some embodiments, the transceiver is further configured to transmit the roaming message to the target AP MLD during the wireless roaming for the resource reservation or negotiation of the frame exchanges between the wireless device and the target AP MLD. In some embodiments, the resource reservation or negotiation of the frame exchanges between the wireless device and the target AP MLD includes a resource reservation or negotiation regarding one of or multiple of Mirrored Stream Classification Service (MSCS), Stream Classification Service (SCS), and block acknowledgement (BA). In some embodiments, the roaming message includes a roaming preparing response frame that includes a Mirrored Stream Classification Service (MSCS) request element, and the wireless transceiver 302 is further configured to transmit the roaming preparing response frame through the serving AP MLD during the wireless roaming for the resource reservation or negotiation regarding MSCS communications between the wireless device and the target AP MLD. In some embodiments, the target AP MLD decides whether the MSCS request element is accepted or rejected, and announces at least one agreed MSCS agreement to the wireless device when accepted. In some embodiments, the roaming message includes a roaming preparing response frame that includes a Stream Classification Service (SCS) request element, and the wireless transceiver 302 is further configured to transmit the roaming preparing response frame through the serving AP MLD during the wireless roaming for the resource reservation or negotiation regarding SCS communications between the wireless device and the target AP MLD. In some embodiments, the target AP MLD decides whether the SCS request element is accepted or rejected and announces at least one agreed SCS agreement in the roaming preparing response frame when accepted. In some embodiments, the current serving AP MLD and the target AP MLD belong to a seamless mobility domain (SMD), and all AP MLDs in the SMD have the same block acknowledgement (BA) agreement capability. In some embodiments, all AP MLDs in the SMD have the same BA bitmap size. A non-AP MLD can have less than or equal to eight downlink (DL) BA agreements and less than or equal to eight uplink (UL) BA agreements. In some embodiments, the roaming message includes a roaming preparing response frame that includes BA parameters, which are used to describe at least one BA agreement, and where the transceiver is further configured to transmit the roaming preparing response frame through the serving AP MLD during the wireless roaming for a negotiation of the at least one BA agreement between the wireless device and the target AP MLD. In some embodiments, the target AP MLD decides whether the at least one BA agreement is accepted or rejected, and announces the at least one BA agreement when accepted. In some embodiments, the roaming message includes a roaming preparing request frame that includes a request block acknowledgement (BA) element that contains the requested BA parameters, which are used to describe a request BA agreement that is different from the current BA agreement(s), and the wireless transceiver 302 is further configured to transmit the roaming preparing request frame to the target MLD through the current serving AP MLD that sends the BA element on behalf of the STA MLD during the wireless roaming for a negotiation of the BA agreement(s) between the wireless device and the target AP MLD. In some embodiments, the target AP MLD decides whether the BA agreement(s) is(are) accepted or rejected. In some embodiments, the target AP MLD always accepts the BA agreement(s). In some embodiments, the wireless device 300 is compatible with an Institute of Electrical and Electronics Engineers (IEEE) 802.11 protocol. In some embodiments, the wireless device includes a non-AP station (STA) MLD, and the wireless transceiver 302 is configured to transmit the roaming message through a wireless link. In some embodiments, the resource reservation or negotiation of the frame exchanges between the wireless device and the target AP MLD includes a resource reservation or negotiation regarding one of or multiple of Emergency Preparedness Communication Service (EPCS), Target Wake Time (TWT), and a Traffic Identifier (TID)-to-link mapping agreement.

In some embodiments, a non-AP STA MLD includes a controller configured to generate a roaming preparing response frame for wireless roaming of the non-AP STA MLD from a current serving AP MLD to a target AP MLD and a transceiver configured to transmit the roaming preparing response frame during the wireless roaming to the target serving AP MLD through the serving AP MLD that sends the roaming preparing response frame on behalf of the non-AP STA MLD to the target AP MLD for a resource reservation or negotiation regarding one of or multiple of Mirrored Stream Classification Service (MSCS), Stream Classification Service (SCS), and block acknowledgement (BA), between the non-AP STA MLD and the target AP MLD.

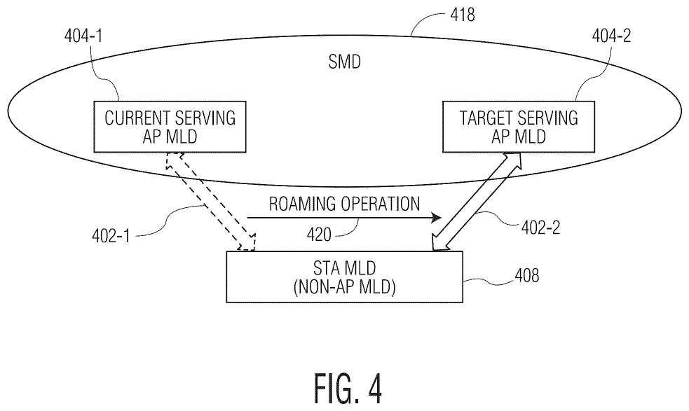

FIG. 4 illustrates a seamless roaming operation 420 of a non-AP (STA) MLD 408 in accordance with example embodiments. In the seamless roaming operation 420 illustrated in FIG. 4, the non-AP (STA) MLD 408 roams from a current serving AP MLD 404-1 of an SMD 418 to a target AP MLD 404-2 of the SMD 418. Specifically, before the seamless roaming operation 420, the non-AP (STA) MLD 408 has the established links 402-1 with the current serving AP MLD 404-1 and conducts the frame exchanges with the current serving AP MLD 404-1. In the seamless roaming operation 420, the non-AP (STA) MLD 408 establishes the links 402-2 with the target serving AP MLD 404-2. Within a temporary duration after the seamless roaming, the non-AP MLD may receive the downlink (DL) data frames from both the current serving AP MLD 404-1 and the target AP MLD 404-2 while transmitting the uplink (UL) data frames to the target AP MLD 404-2 only. In some embodiments, after the temporary duration, the STA MLD 408 stops the frame exchanges with the current serving AP MLD 404-1, and executes the frame exchanges with the target serving AP MLD 404-2.

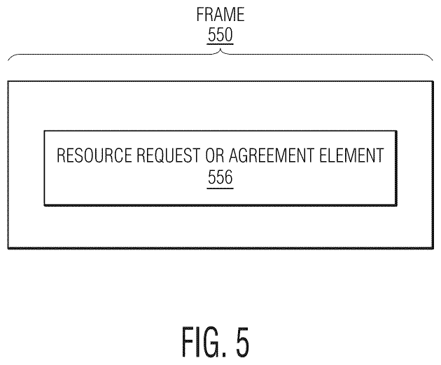

FIG. 5 illustrates a frame format 550 in accordance with example embodiments. The frame format 550 illustrated in FIG. 5 can be used for communications by the wireless communications system 100 depicted in FIG. 1, by a STA/AP affiliated with the multi-link (ML) communications system 200 depicted in FIG. 2, and/or the wireless device 300 depicted in FIG. 3. In the embodiment depicted in FIG. 5, the frame format 550 include a resource request or agreement element 556. In some embodiments, the resource request or agreement element 556 includes information regarding Mirrored Stream Classification Service (MSCS), Stream Classification Service (SCS), block acknowledgement (BA), Emergency Preparedness Communication Service (EPCS), Target Wake Time (TWT), or a Traffic Identifier (TID)-to-link mapping agreement between a non-AP STA MLD and a target AP MLD. In some embodiments, the resource(s) for SCS, MSCS, TWT, EPCS, BA, and/or TID-to-link mapping can be established at a target AP MLD in seamless roaming procedure. In some embodiments, EPCS Enhanced Distributed Channel Access (EDCA) parameters can be announced by a target AP MLD only if the EPCS is enabled by a serving AP MLD. In some embodiments, in a Roaming preparing/executing Response frame, a target AP MLD announces its TID-to-Link mapping scheme if the target AP MLD has TID-to-link mapping policy that is different from a default TID-to-Link mapping scheme. In some embodiments, a non-AP MLD needs to renegotiate the SCS agreement with a target AP MLD by sending a SCS Descriptor element during seamless roaming if the non-AP MLD intends to have a new SCS agreement with the target AP MLD, otherwise the SCS agreement with a serving AP MLD is the SCS agreement with the target AP MLD in which case the target AP MLD can change the start time of various traffic streams (e.g., Service Start Time in QoS Characteristics element) in the SCS agreement to in line with the target AP MLD's restriction. In some embodiments, a target AP MLD announces its supported maximal BA buffer size. In some embodiments, if/when a BA agreement has the BA buffer size that is larger than the target AP MLD's supported maximal BA buffer size, the BA Agreement with the target AP MLD is changed to no more than the maximal BA buffer size supported by the target AP MLD.

In some implementations, a STA and its associated AP can perform a resource negotiation through a (Re)Association Request/Response, for example, regarding Target Wake Time (TWT), Mirrored Stream Classification Service (MSCS). A STA can renegotiate a block acknowledgement (BA) agreement during a fast transition or fast BSS transition (FT) procedure by carrying a Resource Information Container (RIC) element with a block acknowledgement (BA) Set field.

In some implementations, some elements for resource reservation carry the status of a negotiation result. For example, a MSCS element uses an MSCS Status subelement to carry the negotiation result (e.g., accept, reject etc.), a TWT element uses a TWT Setup Command field to carry the negotiation result (e.g., accept, reject etc.). Some elements for resource reservation cannot carry the status of the negotiation result. For example, for a Stream Classification Service (SCS) Descriptor element, the negotiation status is carried in SCS Response frame. Regarding Traffic Identifier (TID)-to-Link Mapping through Association Request/Response, no TID-to-Link Mapping element in Association Response solicited by TID-to-Link Mapping element in association Request means the accepting of the TID-to-Link mapping request. Some resource negotiations use various fields of request/response Action frames instead of elements.

Some implementations of MSCS Negotiation During Seamless Roaming (e.g., Signaling of MSCS negotiation during seamless roaming), for example, by the multi-link (ML) communications system 200 depicted in FIG. 2, and/or the wireless device 300 depicted in FIG. 3 are described.

In some embodiments, in Option 1, an MSCS element is carried in a Roaming preparing Response frame (e.g., a Link Reconfiguration Response frame). In some embodiments, a serving AP MLD sends MSCS requests on behalf of a non-AP MLD that performs seamless roaming. In some embodiments, a target AP MLD decides whether the MSCS requests are accepted or rejected.

In some embodiments, in Option 2, an MSCS element is carried in a Roaming preparing Request/Response frame (e.g., a Link Reconfiguration Request/Response frame). In some embodiments, a serving AP MLD sends MSCS requests on behalf of a non-AP MLD that performs seamless roaming. In some embodiments, in one variant, the Roaming preparing Request carries the MSCS element if the non-AP MLD requests a MSCS configuration that is different from the current agreement. In some embodiments, a target AP MLD decides whether the MSCS requests are accepted or rejected.

In some embodiments, in Option 3, an MSCS element is carried in a Roaming preparing Request/Response frame (e.g., a Link Reconfiguration Request/Response frame). In some embodiments, an MSCS element is optionally carried in a Roaming execution Request/Response frame (e.g., a Link Reconfiguration Request/Response frame). In some embodiments, a serving AP MLD sends MSCS requests on behalf of a non-AP MLD that performs seamless roaming. In some embodiments, in one variant, the non-AP MLD sends the Roaming preparing Request carrying the MSCS element if the non-AP MLD requests a MSCS configuration that is different from the current agreement. In some embodiments, a target AP MLD decides whether the MSCS requests are accepted or rejected, and indicates the agreed MSCS agreement in the Roaming Preparing Response frame.

Some implementations of Stream Classification Service (SCS) Negotiation During Seamless Roaming (e.g., Signaling of SCS negotiation during seamless roaming), for example, by the wireless communications system 100 depicted in FIG. 1, the multi-link (ML) communications system 200 depicted in FIG. 2, and/or the wireless device 300 depicted in FIG. 3 are described.

In some embodiments, in Option 1, a SCS element is carried in a Roaming preparing Response frame (e.g., a Link Reconfiguration Response frame). In some embodiments, a serving AP MLD sends SCS requests on behalf of a non-AP MLD that performs seamless roaming. In some embodiments, a target AP MLD decides whether the SCS requests are accepted or rejected.

In some embodiments, in Option 2, a SCS element is carried in a Roaming preparing Request/Response frame (e.g., a Link Reconfiguration Request/Response frame). In some embodiments, a serving AP MLD sends SCS requests on behalf of a non-AP MLD that performs seamless roaming. In some embodiments, in one variant, the Roaming preparing Request carries the SCS element if the non-AP MLD requests a SCS configuration that is different from the current agreement. In some embodiments, a target AP MLD decides whether the SCS requests are accepted or rejected.

In some embodiments, in Option 3, a SCS element is carried in a Roaming preparing Request/Response frame (e.g., a Link Reconfiguration Request/Response frame). In some embodiments, a SCS element is optionally carried in a Roaming execution Request/Response frame (e.g., a Link Reconfiguration Request/Response frame). In some embodiments, a serving AP MLD sends SCS requests on behalf of a non-AP MLD that performs seamless roaming. In some embodiments, in one variant, the non-AP MLD sends the Roaming preparing Request carrying the SCS element if the non-AP MLD requests a SCS configuration that is different from the current agreement. In some embodiments, a target AP MLD decides whether the SCS requests are accepted or rejected, and indicates the agreed SCS agreements in the Roaming Preparing Response frame.

Some implementations of Same BA agreement Capability among AP MLDs in a Roaming Domain, for example, by the multi-link (ML) communications system 200 depicted in FIG. 2, and/or the wireless device 300 depicted in FIG. 3 are described.

In some embodiments, in Option 1, all the AP MLDs in a seamless roaming domain/seamless mobility domain (SMD) have the same BA agreement capability. In some embodiments, in a first BA agreement capability definition, the same BA agreement capability means the same BA bitmap size. In some embodiments, in a second BA agreement capability definition, the same BA agreement capability means the BA buffer size. In some embodiments, in one variant, the same BA agreement capability is applied to downlink (DL) BA agreement only (AP MLD is the BA agreement originator). In some embodiments, in another variant, the same BA agreement capability is applied to uplink (UL) BA agreement only (non-AP MLD is the BA agreement originator). In some embodiments, in a third variant, the same BA agreement capability is applied to DL BA agreement and UL BA agreement.

In some embodiments, in Option 2, different AP MLDs in a seamless roaming domain have the different BA agreement capabilities (e.g., BA buffer size as A-MPDU receiver, BA bitmap size as A-MPDU transmitter). In some embodiments, in one variant, this is applied to UL BA agreement only (non-AP MLD is the BA agreement originator).

Some implementations of BA Negotiation During Seamless Roaming (e.g., Signaling of BA negotiation during seamless roaming), for example, by the multi-link (ML) communications system 200 depicted in FIG. 2, and/or the wireless device 300 depicted in FIG. 3 are described.

In some embodiments, BA parameters, e.g., a Block Acknowledgement (Ack) Parameter Set, an Add Block Acknowledgment (ADDBA) Extension subelement (or ADDBA Extension field), are used to describe a BA agreement. In some embodiments, one field is defined for indicating whether the Block Acknowledgement Parameter Set(s) and/or the ADDBA Extension field(s) for the DL or UL BA agreement(s) exist. In some embodiments, the location of the Block Ack Parameter Set(s) and/or the ADDBA Extension subelement(s) is used to differentiate the Block Ack Parameter Set(s), the ADDBA Extension field(s) for an UL BA agreement(s) and the Block Ack Parameter Set(s), ADDBA Extension field(s) for a DL BA agreement(s), for example, the first tuple set of Block Ack Parameter and/or the ADDBA Extension field are used for the UL BA agreement(s) and the second tuple set of Block Ack Parameter Set and/or the ADDBA Extension field are used for the DL BA agreement(s). In some embodiments, a new element (e.g., a Seamless Roaming Resource element) is defined to carry the BA parameters of the BA agreement(s).

In some embodiments, in option 1, the BA parameters of the agreed BA agreement(s) are carried in a Roaming Preparing Response frame (e.g., a Link Reconfiguration Response frame). In some embodiments, a serving AP MLD sends the BA requests in a Roaming Preparing Request frame on behalf of a non-AP MLD that performs seamless roaming. In some embodiments, a target AP MLD decides whether the BA requests are accepted or rejected, and announces the parameters of the agreed BA agreement(s) in a Roaming Preparing Response frame.

In some embodiments, the requested/accepted BA parameters are carried in a Roaming Preparing Request/Response frame (e.g., a Link Reconfiguration Request/Response frame) respectively. In some embodiments, a serving AP MLD sends the BA requests in a Roaming Preparing Request frame on behalf of a non-AP MLD that performs seamless roaming. In some embodiments, in one variant, the non-AP MLD sends the Roaming Preparing Request carrying the BA request if the non-AP MLD requests a BA agreement that is different from the current agreement. In some embodiments, a target AP MLD decides whether the BA requests are accepted or rejected, and announces the parameters of agreed BA agreement(s) in the Roaming Preparing Response frame.

In some embodiments, in Option 3, the requested/agreed BA parameters of the BA agreement(s) are carried in a Roaming preparing Request/Response frame (e.g., a Link Reconfiguration Request/Response frame) respectively. In some embodiments, the BA parameters of the BA agreement(s) are optionally carried in a Roaming execution Request/Response frame (e.g., Link Reconfiguration Request/Response frame). In some embodiments, a serving AP MLD sends the BA requests on behalf of a non-AP MLD that performs seamless roaming. In some embodiments, in one variant, the non-AP MLD sends the Roaming preparing Request carrying the BA request if the non-AP MLD requests the BA agreement(s) that is different from the current agreement(s). In some embodiments, a target AP MLD decides whether the BA requests are accepted or rejected, and announces the parameters of agreed BA agreement(s) in a Roaming Preparing Response frame.

Some implementations of TID-to-Link Mapping negotiation During Seamless Roaming, for example, by the multi-link (ML) communications system 200 depicted in FIG. 2, and/or the wireless device 300 depicted in FIG. 3 are described.

In some embodiments, in a Roaming preparing/executing Response frame, a target AP MLD announces its TID-to-Link mapping scheme if the target AP MLD has a TID-to-link mapping policy that is different from the default TID-to-Link mapping scheme (all TIDs are mapped to all the links).

In some embodiments, for a Non-AP MLD's personal TID-to-link mapping scheme, in Option 1, the non-AP MLD is not allowed to negotiate its own TID-to-Link mapping scheme.

In some embodiments, for a Non-AP MLD's personal TID-to-link mapping scheme, in Option 2, the non-AP MLD may negotiate its own TID-to-Link mapping scheme. In some embodiments, the negotiated TID-to-Link mapping takes effect when the non-AP MLD uses the links of the target AP MLD. In some embodiments, TID-to-Link Mapping element for TID-to-Link mapping negotiation is carried in a Roaming preparing Request/Response frame (e.g., a Link Reconfiguration Request/Response frame). In some embodiments, TID-to-Link Mapping element for TID-to-Link mapping negotiation is optionally carried in a Roaming execution Request/Response frame (e.g., a Link Reconfiguration Request/Response frame).

Some implementations of TWT Negotiation During Seamless Roaming (e.g., Signaling of TWT negotiation during seamless roaming), for example, by the multi-link (ML) communications system 200 depicted in FIG. 2, and/or the wireless device 300 depicted in FIG. 3 are described.

In some embodiments, a Link ID Bitmap field is added in a Broadcast TWT Parameter Set field (e.g., at the end of a Broadcast TWT Parameter Set field). In some embodiments, the Target Wake Time field for a broadcast TWT agreement negotiation indicates the (partial) Timing synchronization function (TSF) time of the related link (defined by Link ID Bitmap field) at a target AP MLD.

In some embodiments, the Target Wake Time field for individual TWT agreement negotiation indicates the (partial) TSF time of the related link (defined by Link ID Bitmap field) at a target AP MLD.

In some embodiments, in Option 1, a TWT element is carried in a Roaming preparing Response frame (e.g., a Link Reconfiguration Response frame).

In some embodiments, in Option 2, a TWT element is carried in a Roaming preparing Request/Response frame (e.g., a Link Reconfiguration Request/Response frame).

In some embodiments, in Option 3, a TWT element is carried in a Roaming preparing Request/Response frame (e.g., a Link Reconfiguration Request/Response frame). In some embodiments, a TWT element is optionally carried in a Roaming execution Request/Response frame (e.g., a Link Reconfiguration Request/Response frame).

Some implementations of Emergency Preparedness Communication Services (EPCS) during Seamless Roaming, for example, by the wireless communications system 100 depicted in FIG. 1, the multi-link (ML) communications system 200 depicted in FIG. 2, and/or the wireless device 300 depicted in FIG. 3 are described.

In some embodiments, a non-AP MLD with EPCS being enabled conducts or executes seamless roaming. In some embodiments, if/when a serving AP MLD enables a non-AP MLD's EPCS, a target AP MLD supporting EPCS needs also to enable the non-AP MLD's EPCS. Since the EDCA parameters for EPCS could be different in the serving AP MLD and the target AP MLD, the non-AP MLD that has its EPCS being enabled needs to acquire the target AP MLD's EPCS EDCA parameter set. In some embodiments, an EPCS Priority Access Multi-Link element is carried in a Roaming preparing Request/Response frame (e.g., a Link Reconfiguration Request/Response frame). In some embodiments, in one variant, the Roaming preparing Request frame does not carry the EPCS Priority Access Multi-Link element. In some embodiments, the EPCS Priority Access Multi-Link element is optionally carried in a Roaming execution Request/Response frame (e.g., a Link Reconfiguration Request/Response frame). In some embodiments, in one variant, the Roaming execution Request frame does not carry the EPCS Priority Access Multi-Link element.

In some embodiments, a non-AP MLD without EPCS being enabled conducts or executes seamless roaming. In some embodiments, in Option 1, the EPCS cannot be enabled in a target AP MLD through a seamless roaming procedure. In some embodiments, the target AP MLD notifies the EDCA parameters of EPCS in its links to the non-AP MLD. In some embodiments, in Option 2, the EPCS can be enabled in the target AP MLD through a seamless roaming procedure.

Some implementations of Resource Acceptation/Rejection, for example, by the multi-link (ML) communications system 200 depicted in FIG. 2, and/or the wireless device 300 depicted in FIG. 3 are described.

In some embodiments, in Option 1, resource parameters, e.g., BA parameters, SCS parameters, MSCS parameters, in a response frame are the resource being accepted.

In some embodiments, in Option 2, a response frame indicates whether the requested resource parameters, e.g., BA parameters, SCS parameters, MSCS parameters, are accepted or rejected.

Some implementations of Preferred TID Indication in Basic Trigger, for example, by the wireless communications system 100 depicted in FIG. 1, the multi-link (ML) communications system 200 depicted in FIG. 2, and/or the wireless device 300 depicted in FIG. 3 are described.

In some embodiments, in a Basic Trigger frame, the Preferred TID indication is used instead of Preferred AC (access category). In some embodiments, an AP transmits a Basic Trigger frame with a Preferred TID field to indicate the preferred TID. In some embodiments, in Restricted Target Wake Time (R-TWT), the Preferred TID for a STA as the R-TWT member needs to match the TID of the R-TWT negotiated by the STA. In some embodiments, the STA addressed by the Basic Trigger frame is recommended to transmit the frames from the TID indicated by the Preferred TID field for it.

In some embodiments, a method of reserving the resource for frame exchanges with a first device 2 after a second device's roaming from a first device 1 to the first device 2 includes sending, by the second device, a roaming preparing Request and roaming executing Request for its roaming from first device 1 to first device 2, and Announcing, by the first device 2, the resource for the frame exchanges between it and the second device through unsolicited method or solicited method. In some embodiments, the resource includes MSCS, SCS, BA. In some embodiments, in a Roaming preparing/executing Response frame, the first device 2 announces its TID-to-Link mapping scheme if the target AP MLD has TID-to-link mapping policy different from the default TID-to-Link mapping scheme. In some embodiments, in the Roaming preparing/executing Response frame, the first device 2 announces the BA parameters of UL BA agreements and DL BA agreements. In some embodiments, the first device 2 announces the smaller BA buffer sizes of UL BA agreements and DL BA agreements if the first device 2 cannot support the second device's UL BA agreements and DL BA agreements with the first device 1.

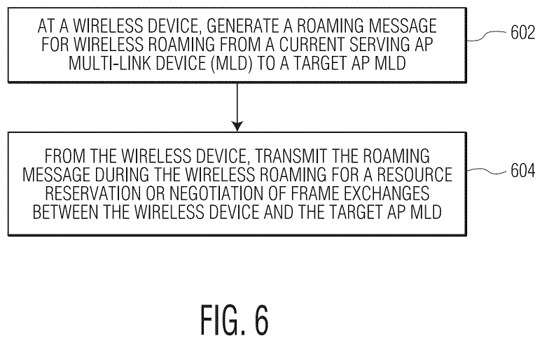

FIG. 6 is a process flow diagram of a method for wireless communications in accordance with example embodiments. At block 602, at a first wireless device, a roaming message for wireless roaming from a current serving AP multi-link device (MLD) to a target AP MLD is generated. At block 604, from the first wireless device, the roaming message is transmitted during the wireless roaming for a resource reservation or negotiation of frame exchanges between the wireless device and the target AP MLD. In some embodiments, the wireless device includes a non-AP MLD with at least one affiliated non-AP station (STA). In some embodiments, the roaming message includes a roaming preparing request or response frame or a roaming executing request or response frame. In some embodiments, the roaming message is transmitted through the current serving AP MLD during the wireless roaming for the resource reservation or negotiation of the frame exchanges between the wireless device and the target AP MLD. In some embodiments, the roaming message is transmitted to the target AP MLD during the wireless roaming for the resource reservation or negotiation of the frame exchanges between the wireless device and the target AP MLD. In some embodiments, the resource reservation or negotiation of the frame exchanges between the wireless device and the target AP MLD includes the resource reservation or negotiation regarding one of or multiple of Mirrored Stream Classification Service (MSCS), Stream Classification Service (SCS), and block acknowledgement (BA). In some embodiments, the roaming message includes a roaming preparing response frame that includes a Mirrored Stream Classification Service (MSCS) element, and the roaming preparing response frame is transmitted through the current serving AP MLD during the wireless roaming for the resource reservation or negotiation regarding MSCS communications between the wireless device and the target AP MLD. In some embodiments, the target AP MLD decides whether the MSCS element is accepted or rejected and announces at least one agreed MSCS agreement to the wireless device when accepted. In some embodiments, the roaming message includes a roaming preparing response frame that includes a Stream Classification Service (SCS) element, and the roaming preparing response frame is transmitted through the current serving AP MLD during the wireless roaming for the resource reservation or negotiation regarding SCS communications between the wireless device and the target AP MLD. In some embodiments, the target AP MLD decides whether the SCS element is accepted or rejected and announces at least one agreed SCS agreement in the roaming preparing response frame when accepted. In some embodiments, the current serving AP MLD and the target AP MLD belong to a seamless mobility domain (SMD), and all AP MLDs in the SMD have the same block acknowledgement (BA) agreement capability. In some embodiments, all AP MLDs in the SMD have the same BA bitmap size. In some embodiments, the roaming message includes a roaming preparing response frame that contains BA parameters, which are used to describe a BA agreement, and the roaming preparing response frame is transmitted through the current serving AP MLD during the wireless roaming for a negotiation of the BA agreement(s) between the wireless device and the target AP MLD. In some embodiments, the target AP MLD decides whether the BA agreement(s) is (are) accepted or rejected, and announces the parameters of the agreed BA agreement(s). In some embodiments, the wireless device is compatible with an Institute of Electrical and Electronics Engineers (IEEE) 802.11 protocol. In some embodiments, the wireless device includes a non-AP station (STA) MLD, and the roaming message is transmitted through a wireless link. In some embodiments, the resource reservation or negotiation of the frame exchanges between the wireless device and the target AP MLD includes a resource reservation or negotiation regarding one of or multiple of Emergency Preparedness Communication Service (EPCS), Target Wake Time (TWT), and a Traffic Identifier (TID)-to-link mapping agreement.

The wireless device may be the same as or similar to an embodiment of the STA 110-1, . . . , or 110-n depicted in FIG. 1, the STAs 210-1, 210-2 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, example embodiments may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the claims is to be defined by the claim language and their equivalents.

What is claimed is:

1. A wireless device comprising:
a controller configured to generate a roaming message for wireless roaming from a current serving access point (AP) multi-link device (MLD) to a target AP MLD; and
a transceiver configured to transmit the roaming message during the wireless roaming for a resource reservation or negotiation of a plurality of frame exchanges between the wireless device and the target AP MLD.

2. The wireless device of claim 1, wherein the wireless device comprises a non-AP MLD with at least one affiliated non-AP station (STA).

3. The wireless device of claim 1, wherein the roaming message comprises a roaming preparing request or response frame or a roaming executing request or response frame.

4. The wireless device of claim 1, wherein the transceiver is further configured to transmit the roaming message through the serving AP MLD during the wireless roaming for the resource reservation or negotiation of the frame exchanges between the wireless device and the target AP MLD.

5. The wireless device of claim 1, wherein the transceiver is further configured to transmit the roaming message to the target AP MLD during the wireless roaming for the resource reservation or negotiation of the frame exchanges between the wireless device and the target AP MLD.

6. The wireless device of claim 1, wherein the resource reservation or negotiation of the frame exchanges between the wireless device and the target AP MLD comprises the resource reservation or negotiation regarding one of or multiple of Mirrored Stream Classification Service (MSCS), Stream Classification Service (SCS), and block acknowledgement (BA).

7. The wireless device of claim 1, wherein the roaming message comprises a roaming preparing response frame that comprises a Mirrored Stream Classification Service (MSCS) element, and wherein the transceiver is further configured to transmit the roaming preparing response frame through the serving AP MLD during the wireless roaming for the resource reservation or negotiation regarding MSCS communications between the wireless device and the target AP MLD.

8. The wireless device of claim 7, wherein the target AP MLD decides whether the MSCS element is accepted or rejected, and announces an agreed MSCS agreement to the wireless device when accepted.

9. The wireless device of claim 1, wherein the roaming message comprises a roaming preparing response frame that comprises a Stream Classification Service (SCS) element, and wherein the transceiver is further configured to transmit the roaming preparing response frame through the serving AP MLD during the wireless roaming for the resource reservation or negotiation regarding SCS communications between the wireless device and the target AP MLD.

10. The wireless device of claim 9, wherein the target AP MLD decides whether the SCS element is accepted or rejected, and announces an agreed SCS agreement in the roaming preparing response frame.

11. The wireless device of claim 1, wherein the current serving AP MLD and the target AP MLD belong to a seamless mobility domain (SMD), and wherein all AP MLDs in the SMD have same block acknowledgement (BA) agreement capability.

12. The wireless device of claim 11, wherein the all AP MLDs in the SMD have same BA bitmap size.

13. The wireless device of claim 1, wherein the roaming message comprises a roaming preparing response frame that comprises a plurality of block acknowledgement (BA) parameters, which are used to describe a BA agreement, and wherein the transceiver is further configured to transmit the roaming preparing response frame through the serving AP MLD during the wireless roaming for a negotiation of the BA agreement between the wireless device and the target AP MLD.

14. The wireless device of claim 13, wherein the target AP MLD decides whether the BA agreement is accepted or rejected, and announces the BA agreement when accepted.

15. The wireless device of claim 1, wherein the wireless device is compatible with an Institute of Electrical and Electronics Engineers (IEEE) 802.11 protocol.

16. The wireless device of claim 1, wherein the wireless device comprises a non-AP station (STA) MLD, and wherein the transceiver comprises a wireless transceiver configured to transmit the roaming message through a wireless link.

17. The wireless device of claim 1, wherein the resource reservation or negotiation of the frame exchanges between the wireless device and the target AP MLD comprises a resource reservation or negotiation regarding one of or multiple of Emergency Preparedness Communication Service (EPCS), Target Wake Time (TWT), and a Traffic Identifier (TID)-to-link mapping agreement.

18. A non-AP station (STA) multi-link device (MLD) comprising:
a controller configured to generate a roaming preparing response frame for wireless roaming from a current serving access point (AP) MLD to a target AP MLD; and
a transceiver configured to transmit the roaming preparing response frame during the wireless roaming to the current serving AP MLD that sends the roaming preparing response frame on behalf of the non-AP STA MLD to the target AP MLD for a resource reservation or negotiation regarding Mirrored Stream Classification Service (MSCS), Stream Classification Service (SCS), and block acknowledgement (BA) between the non-AP STA MLD and the target AP MLD.

19. A method for wireless communications, the method comprising:
at a wireless device, generating a roaming message for wireless roaming from a current serving access point (AP) multi-link device (MLD) to a target AP MLD; and
from the wireless device, transmitting the roaming message during the wireless roaming for a resource reservation or negotiation of a plurality of frame exchanges between the wireless device and the target AP MLD.

20. The method of claim 19, wherein the wireless device comprises a non-AP MLD with at least one affiliated non-AP station (STA).
